(19) United States
(12) Patent Application Publication
(10) Pub. No.: US 2015/0267540 A1
(43) Pub. Date: Sep. 24, 2015

(54) METHODS OF MANUFACTURING BLADES OF TURBOMACHINES BY WIRE ELECTRIC DISCHARGE MACHINING, BLADES AND TURBOMACHINES

(71) Applicant: NUOVO PIGNONE SRL, Florence (IT)

(72) Inventors: Marco Grilli, Florence (IT); Massimo Arcioni, Florence (IT); Enrico Giusti, Florence (IT); Massimiliano Cecconi, Florence (IT)

(21) Appl. No.: 14/439,845

(22) PCT Filed: Oct. 25, 2013
(86) PCT No.: PCT/EP2013/072383

§ 371 Date: Apr. 30, 2015

(30) Foreign Application Priority Data
Oct. 31, 2012 (IT) CO2012A000054

(51) Int. Cl. F01D 5/14; B23H 9/10; B23H 7/02; F01D 5/18

(52) U.S. Cl. CPC F01D 5/147; F01D 5/18; B23H 9/10; B23H 7/02

(57) ABSTRACT

The method is used for manufacturing a blade of a turbomachine comprising an airfoil portion; according thereto at least one external or internal surface of the airfoil portion is obtained by wire electric discharge machining; this is allowed by designing these surfaces as “ruled surfaces” or very close to such kind of surfaces; this method is particularly effective, for forming internal cavities of hollow stator blades of steam turbines; this method allows to manufacture in a single piece hollow blades having root portions and shroud portions. Blade of a turbomachine with an internal cavity wherein the surface of the airfoil of the blade inside the cavity defines grooves perpendicular to the axis of the turbomachine.

### BACKGROUND OF THE INVENTION

Embodiments of the subject matter disclosed herein generally relate to blades for turbomachines, turbomachines using such blades and methods of manufacturing such blades; more specifically, they relate to stator blades for steam turbines, steam turbines using such blades and methods of manufacturing such blades.

In steam turbines, partial condensation of the steam occurs at their last stage or stages.

In particular condensation occurs on the airfoil portion of the stator blades of a so-called “condensing stage”, typically the last stage of the turbine.

If droplets are generated as a consequence of condensation, they leave the static stator blades and they hit the rotating rotor blades; therefore, damages to the rotor blades may occur.

In order to reduce the damages caused by the droplets, the rotation speed of the rotor blades may be reduced; but in this way, the efficiency of the turbine is also reduced.

Alternatively, in order to reduce any damage on the rotor blades, solutions exist for collecting the condensation before the generation of droplets.

The most typical of these solutions consists in using hollow stator blades where condensation is likely to occur, providing holes and/or slots through the airfoil portion of the blades extending from the airfoil surface to the internal cavity, and sucking from the internal cavity so to that any condensation leaves the airfoil surface and enters the internal cavity. In this way, droplets on the airfoil surface of the stator blades are not generated and released—to be precise, droplets generation can not be completely avoided, but is simply highly reduced.

Manufacturing of a hollow stator blade for steam turbines has traditionally been done by starting from two metal sheets; thereafter, the two metal sheets were molded in such a way as to form two half-shells; then, the two half-shells were welded together; finally, some finishing was often done.

Sometimes, a different manufacturing method has more recently been used (see e.g. FIG. 1):

taking two metal bars,

milling them separately so to define the surface of the internal cavity (see e.g. FIG. 1A),

welding them together so to obtain a hollow piece (see e.g. FIG. 1B),

mill finishing the hollow piece so to define the airfoil surface (see e.g. FIG. 1C).

This manufacturing method allows to define quite precisely the internal surface of the blade, i.e. the surface of the internal cavity, and quite precisely the external surface of the blade, i.e. the airfoil surface. Anyway, it is quite expensive as the milling operation (for the inside and the outside) is relatively slow.

In turbines, especially gas turbines, hollow blades are sometime used for rotor blades in order to reduce weight of the rotating element. These hollow blades are typically obtained through casting, particularly “investment casting”, in order to obtain a rotating element having an extremely precise shape and size; anyway, this manufacturing method is very expensive especially when used for small-lot production (for example 100-1000 pieces).

### SUMMARY

Therefore, there is a general need for a solution of blades, in particular steam turbine hollow blades, allowing an easier and more economical manufacturing without sacrificing shape and/or size precision. In particular, there is a need for a manufacturing method that does not require molds and that does require limited or no milling and/or finishing and that is different from casting.

Additionally, it would be desirable to obtain a hollow blade in a single piece integrating not only the airfoil portion but also a root portion and a shroud portion.

Anyway, if the airfoil portion, the root portion and the shroud portion should be three separated pieces, it would be desirable to join them easily.

Finally, it would be desirable to manufacture modules comprising a set of steam turbine hollow blades in an easy way.

It is to be considered that one of the ultimate goals is to manufacture a whole steam turbine having good performances in a relatively easy way and at a reasonable cost.

The present inventors started from the realization that for a steam turbine hollow blade the shaped on the surface of the internal cavity is not particularly critical; this is quite different from the internal cavity of other kinds of hollow blades. On the other side, the shape of the airfoil surface is very important.

At the light of these observations, they thought of (A) realizing the blade in a single peace, (B) using milling for the airfoil surface so that its shape would be extremely precise, (C) using Wire Electric Discharge Machining, i.e. Wire EDM, for the internal cavity so that it would be sufficiently simple and easy to be realized and its shape would be sufficiently precise, i.e. the internal surface of the blade would much sufficiently well with the external surface of the blade.

By using Wire EDM, the surface of the internal cavity is a “ruled surface”.

In this way, no welding is necessary for manufacturing the blade, the precision of the machine surface or surfaces of the blade is extremely high, and the thickness of the lateral wall of the airfoil portion of the blade may be very low.

This manufacturing method is particularly suitable and convenient for small-lot production (for example 100-1000 pieces).

The present inventors realized afterwards that the Wire EDM was suitable for forming not only the internal surface of a hollow turbine blade but also for forming both the internal and the external surfaces of a blades, even for long (for example up to 1000 mm) blades, provided these surfaces are designed as “ruled surfaces” or very close to such kind of surfaces.

A first aspect of the present invention is a blade for a turbomachine.

According to embodiments thereof, a blade for a turbomachine comprises an airfoil portion, wherein said airfoil portion extends longitudinally for a length and has a first end and a second end, wherein said airfoil portion is defined laterally by an airfoil surface, and wherein said airfoil surface is a ruled surface.

According to alternative embodiments thereof, a blade for a turbomachine comprises an airfoil portion, wherein said airfoil portion extends longitudinally for a length and has a first end and a second end, wherein said airfoil portion is defined laterally by an airfoil surface, wherein said airfoil portion has an internal cavity extending entirely along said length, and wherein said internal cavity is defined laterally by a ruled surface.

Said airfoil surface may be a ruled surface.

The blade may be arranged as a stator blade for a steam turbine comprising a root portion, a shroud portion and an airfoil portion, wherein said airfoil portion extends longitudinally for a length and has a first end and a second end, said first end being adjacent to said root portion and said second end being adjacent to said shroud portion, wherein said airfoil portion is defined laterally by an airfoil surface, wherein said airfoil portion has an internal cavity extending entirely along said length, and wherein said internal cavity is defined laterally by a ruled surface.

At any point of the airfoil portion the distance (measured transversally to the blade) between said airfoil surface and said ruled surface may be variable.

At any point of the airfoil portion, the distance (measured transversally to the blade) between said airfoil surface and said ruled surface may be greater than 1 mm and smaller than 5 mm.

At said first end there is a first offset between said airfoil surface and said ruled surface; said first offset may be constant and may be in the range from 1 mm and 5 mm.

At said second end there is a second offset between said airfoil surface and said ruled surface; said second offset may be constant and may be in the range from 1 mm and 5 mm.

Said root portion, said shroud portion and said airfoil portion may be in a single piece, and said ruled surface may extend also through said root portion and said shroud portion.

Said root portion and said shroud portion may be joined to said airfoil portion at said first and second ends. In this case, said root portion has a first (through) hole having a shape corresponding to the shape of said ruled surface at said first end, and said shroud portion has a second (through) hole having a shape corresponding to the shape of said ruled surface at said second end.

Said root portion may comprise a first sleeve having an external surface mating with said ruled surface of said airfoil portion at said first end. In this case, said first sleeve may have a first through hole defined laterally by a ruled surface.

Said shroud portion may have a second sleeve having an external surface mating with said ruled surface of said airfoil portion at said second end. In this case, said second sleeve may have a second through hole defined laterally by a ruled surface.

The blade may comprise one single root portion, one single shroud portion and a plurality of airfoil portions, wherein each of said airfoil portions extends longitudinally for a length and has a first end and a second end, each of said first ends being adjacent to said root portion and each of said second ends being adjacent to said shroud portion, wherein each of said airfoil portions is defined laterally by an airfoil surface, wherein each of said airfoil portion has an internal cavity extending entirely along said length, and wherein said internal cavity is defined laterally by a ruled surface.

Said root portion may be or comprise a plate, said plate being substantially flat or curved and having a hole.

Said shroud portion may be or comprise a plate, said plate being substantially flat or curved and having a hole.

Said airfoil portion typically has holes or slots extending from said airfoil surface to said internal cavity.

A second aspect of the present invention is a turbomachine.

According to embodiments thereof, a turbomachine comprises a plurality of blades as set out above.

The turbomachine may be arranged as a steam turbine and comprising a plurality of stator blades as set out above (in particular with an internal cavity defined laterally by a ruled surface and integrating a root portion, a shroud portion and an airfoil portion).

The turbomachine may comprise a plurality of stages, wherein stator blades as set out above (in particular with an internal cavity defined laterally by a ruled surface and integrating a root portion, a shroud portion and an airfoil portion) are used only for the last stages.

The turbomachine may comprise a plurality of stages starting with a first stage and ending with a last stage, wherein (typically only) said last stage comprises a plurality of stator blades as set out above (in particular with an internal cavity defined laterally by a ruled surface and integrating a root portion, a shroud portion and an airfoil portion).

The turbomachine may comprise an inner ring and a plurality of stator blades as set out above, wherein each of root portions of said stator blades are fixed (i.e. welded or inserted and welded or push fitted and welded) to said inner ring.

The turbomachine may comprise an outer ring and a plurality of stator blades as set out above, wherein each of shroud portions of said stator blades are fixed (i.e. welded or inserted and welded and push fitted and welded) to said outer ring.

The turbomachine may be an axial-flow turbine.

A third aspect of the present invention is a method of manufacturing a blade of a turbomachine.

According to embodiments thereof, a method of manufacturing a blade of a turbomachine comprising an airfoil portion at least one external or internal surface of said airfoil portion is obtained by wire electric discharge machining.

Said airfoil portion may extend longitudinally for a length and have a first end and a second end, wherein said airfoil portion may be defined laterally by an airfoil surface, and wherein said airfoil surface may be obtained by wire electric discharge machining.

Said airfoil portion may extend longitudinally for a length and have a first end and a second end, wherein said airfoil portion is defined laterally by an airfoil surface, wherein said airfoil portion may have an internal cavity extending entirely along said length, wherein said internal cavity may be defined laterally by an internal surface, and wherein said internal surface may be obtained by wire electric discharge machining.

The manufacturing method may comprise the steps of:

A) providing a bar made of metal,

B) milling said bar externally, and

C) wire electric discharge machining said bar internally so that a through hole is obtained defined by a ruled surface.

Said through hole may have a length greater than 50 mm and smaller than 1000 mm.

The manufacturing method may comprise the further step of forging said bar prior to milling it.

Through step B external surfaces of said root portion, said shroud portion and said airfoil portion may be obtained.

Through step B only an external surface of said airfoil portion may be obtained.

At said first end there is a first offset between said airfoil surface and said ruled surface, and wherein step C may be carried out so that said first offset being constant.

At said second end there is a second offset between said airfoil surface and said ruled surface, and wherein step C may be carried out so that said second offset being constant.

Said root portion may be (laser) welded to said airfoil portion at said first end.

Said shroud portion may be (laser) welded to said airfoil portion at said second end.

A plurality of airfoil portions may be (laser) welded to the same root portion.

A plurality of airfoil portions may be (laser) welded to the same shroud portion.

Said root portion and said airfoil portion may be brazed together at said first end.

Said shroud portion and said airfoil portion may be brazed together at said second end.

Said root portion may have a first through hole, and said first through hole may be obtained by wire electric discharge machining.

Said shroud portion may have a second through hole, and said second through hole may be obtained by wire electric discharge machining.

Said root portion may be (laser) welded to an inner ring of a steam turbine.

Said shroud portion may be (laser) welded to an outer ring of a steam turbine.

Through step B at least an external surface of said airfoil portion may be obtained; in this case, the further step of making (transversal) holes or slots extending from said external surface to said (longitudinal) through hole is carried out after step C. Said holes or slots are, in an embodiment, obtained by electric discharge machining.

Through step B at least an external surface of said airfoil portion may be obtained; in this case, the further step of making (transversal) holes or slots extending from said external surface to said (longitudinal) through hole is carried out before step C. Said holes or slots are, in an embodiment, obtained by laser drilling or cutting.

### BRIEF DESCRIPTION OF DRAWINGS

The accompanying drawings, which are incorporated herein and constitute a part of the specification, illustrate embodiments of the present invention and, together with the description, explain these embodiments. In the drawings:

FIG. 1 shows very schematically a manufacturing method of a steam turbine hollow blade that can be implemented according to the prior art or according to the present invention,

FIG. 2 shows very schematically a first manufacturing method of a steam turbine hollow blade according to the present invention,

FIG. 3 shows very schematically a second manufacturing method of a steam turbine hollow blade according to the present invention,

FIG. 4 shows very schematically a first possibility of assembling a steam turbine hollow blade according to the present invention following the method shown in FIG. 2,

FIG. 5 shows very schematically a second possibility of assembling a steam turbine hollow blade according to the present invention following the method shown in FIG. 2,

FIG. 6 shows very schematically a first possibility of assembling a steam turbine hollow blade module according to the present invention,

FIG. 7 shows very schematically and partially a first steam turbine stage according to the present invention,

FIG. 8 shows very schematically a second possibility of assembling a steam turbine hollow blade module according to the present invention,

FIG. 9 shows very schematically and partially a second steam turbine stage according to the present invention,

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims.

It is to be noted that in the accompanying drawings sometimes sizes have been exaggerated for the sake of clarity; in other words they are not perfectly in scale between each other.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

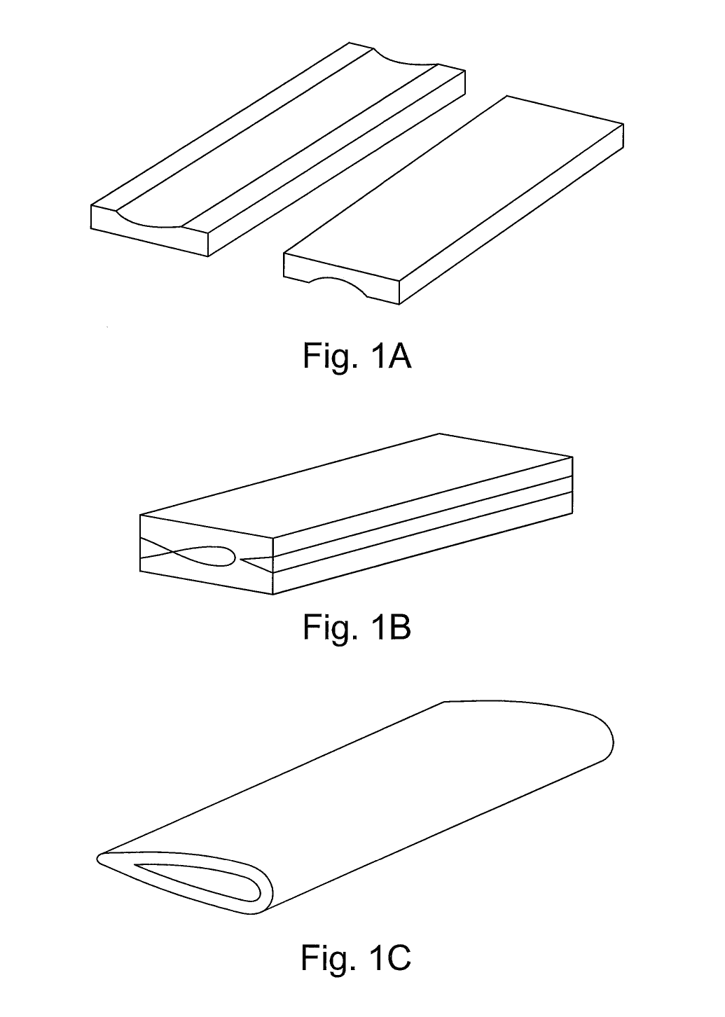

The blades of a turbomachine (a compressor, an expander, a turbine, . . . ) consist of or comprise an airfoil portion. The airfoil portion extends longitudinally for a certain length between a first end and a second end; in general, its cross-section varies along its length. The airfoil portion has basically one surface to be formed that is the “external lateral surface” or “airfoil surface” of the blade that is very important for the operation of the airfoil portion. For certain applications, the airfoil portion is hollow, i.e. it has an internal cavity that, depending on the specific application and the specific design, extends entirely or partially along its length; for example, in the blade of FIG. 1, the internal cavity extends along the entire length of the blade. The internal cavity is defined laterally by a surface that may be called the “internal lateral surface” or, simply, the “internal surface” of the blade; in general, the cross-section of the internal cavity varies along its length; anyway, depending on the specific application and the specific design, the variation in the cross-section of the internal cavity may be different from the variation in the cross-section of the airfoil portion; in other words the thickness of the lateral wall of the airfoil portion may vary along its length and even from point to point.

According to the present invention, at least one external or internal surface of the airfoil portion is obtained by wire electric discharge machining, i.e. “Wire EDM”. This particularly applies to the blades of turbomachines for “Oil & Gas” applications; for the last stage of a steam turbine, stator blades have a length in the range from 50 mm up to 1000 mm.

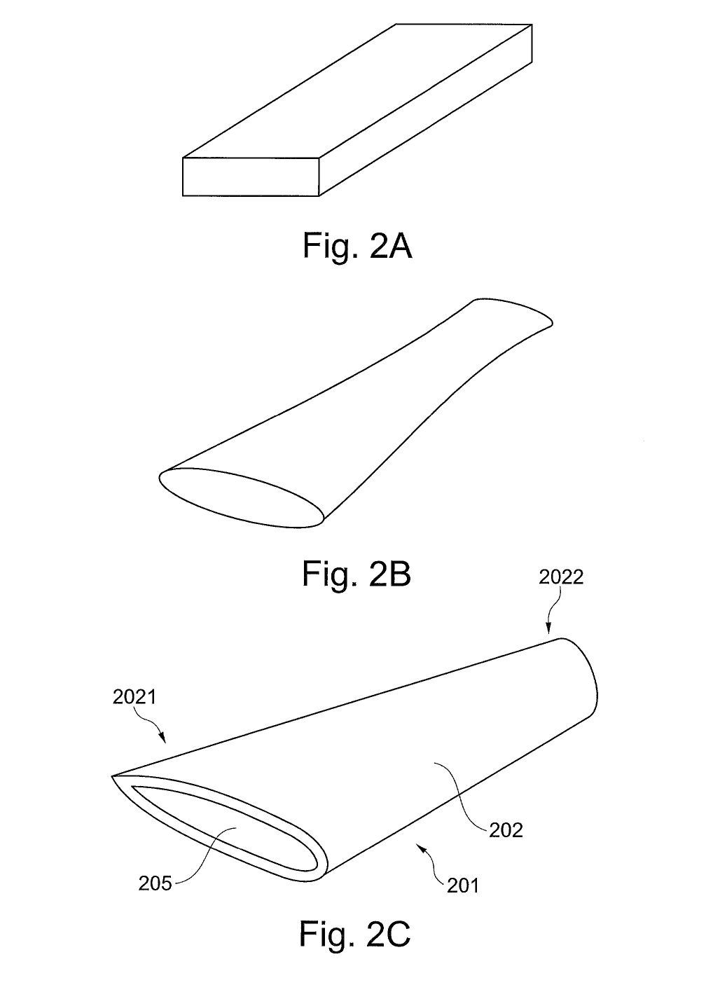

A first possibility is to form by Wire EDM only the external surface, i.e. the airfoil surface; for example, Wire EDM may be used, in FIG. 1, for machining the piece of FIG. 1B and obtaining the piece of FIG. 1C, and, in FIG. 2, for machining the piece of FIG. 2A and obtaining the piece of FIG. 2B.

A second possibility is to form by Wire EDM only the internal surface, i.e. the surface of the internal cavity; for example, Wire EDM may be used, in FIG. 1, for machining two separate bars and obtaining the two pieces of FIG. 1A, and, in FIG. 2, for machining the piece of FIG. 2B and obtaining the piece of FIG. 2C.

A third possibility is to form by Wire EDM both the external surface and the internal surface of the airfoil portion.

By Wire EDM only a “ruled surface” may be obtained; it is to be noticed that, by this term, it is meant not only a “simple” ruled surface, but also a “complex” ruled surface deriving from a combination of two or more ruled surfaces, for example a large conical surface at the bottom and a small cylindrical surface at the top.

Although many differences surfaces may be obtained by Wire EDM, if this technology is to be used, the design of the blade should take it into account; for example, the aim should be to find ideal shapes of the surfaces of the blade that are exactly ruled surfaces or are sufficiently close to ruled surfaces. When this is not possible, milling can be used instead of Wire EDM; it is to be noticed that, depending on the specific application, the need for milling, instead of Wire EDM, may apply to any of the blade surface. For sure, Wire EDM may, in an embodiment, be used when shape and size precisions are not extremely high such as for the surface of the internal cavity of a stator blade of a steam turbine.

With reference to FIG. 2, a manufacturing method of a blade 201, consisting only in an airfoil portion 202, comprises the steps of:

A) providing a bar made of metal (FIG. 2A),

B) milling the bar externally (FIG. 2B), and

C) wire electric discharge machining the bar internally so that a through hole 205 is obtained defined by a ruled surface (FIG. 2C).

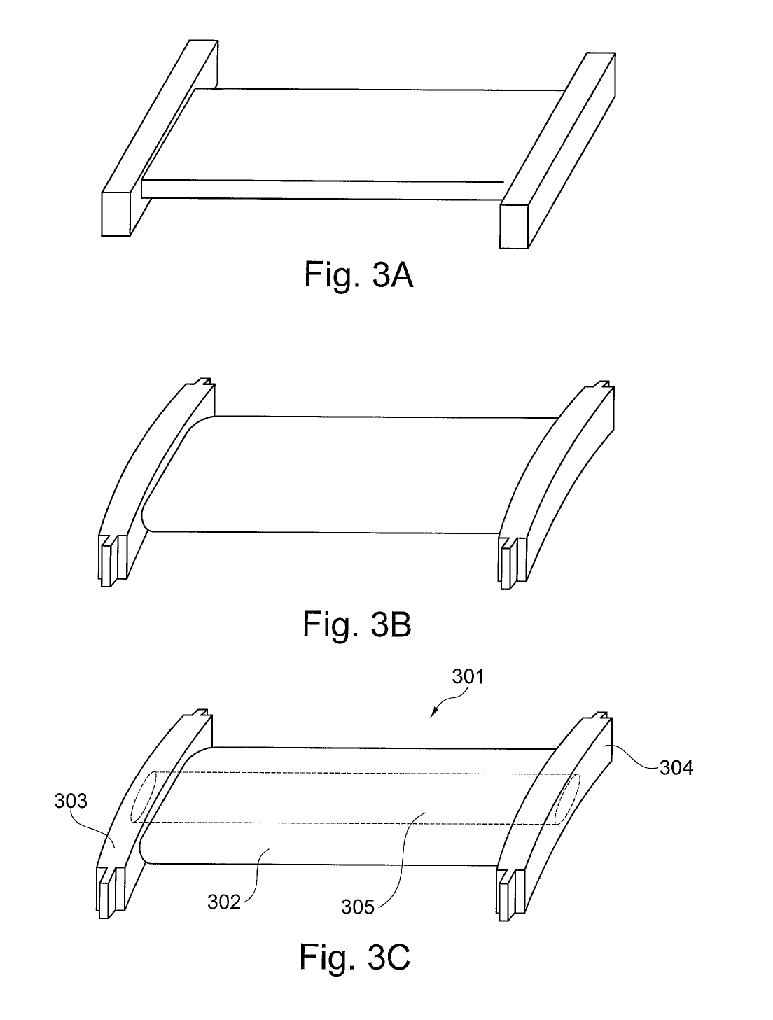

With reference to FIG. 3, a manufacturing method of a blade 301 comprises the steps of: providing a bar made of metal, forging the bar (FIG. 3A), milling the bar externally (FIG. 3B), and wire electric discharge machining the bar internally so that a through hole 305 is obtained defined by a ruled surface (FIG. 3C).

According to the embodiment of FIG. 3, by first forging and then milling, not only the external surface of the airfoil portion 302 is obtained, but also the external surfaces of a root portion 303 and a shroud portion 304 both adjacent to the airfoil portion 302; the through hole 305 extends not only along the entire length of the airfoil portion 302, but also inside the root portion 303 and the shroud portion 304; in this case the root portion and the shroud portion are integral with the airfoil portion.

According to those embodiments of the present invention wherein the airfoil portion is not integral with case the root portion and the shroud portion, one step of the manufacturing method is used for forming only the external surface of the airfoil portion (see e.g. FIG. 2B).

In this case, at a first end (2021 in FIG. 2C) of the airfoil portion there is a first offset between the airfoil surface and the ruled surface, and Wire EDM may be carried out so that this first offset be constant.

In this case, at a second end (2022 in FIG. 2C) of the airfoil portion there is a second offset between the airfoil surface and the ruled surface, and Wire EDM may be carried out so that this second offset be constant.

Typically these two features are implemented together.

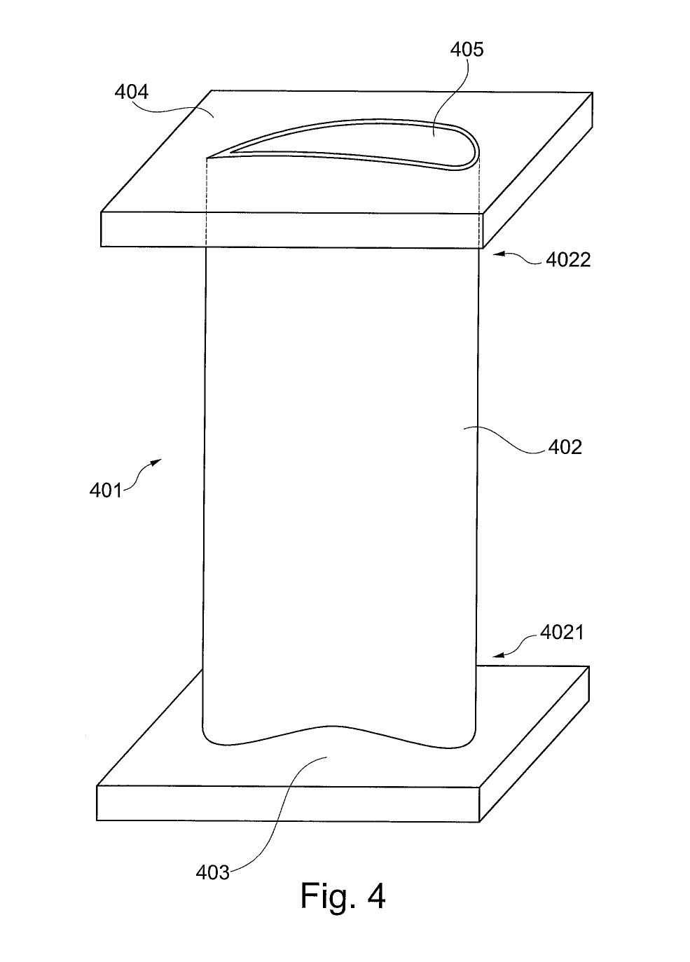

The embodiment of FIG. 4, is a blade 401 comprising an airfoil portion 402, a root portion 403 and a shroud portion 404; the airfoil portion 402 may be manufactured similarly to the airfoil portion 202 in FIG. 2.

The root portion 403 is welded, in an embodiment, laser welded, to the airfoil portion 402 at a first end 4021 thereof.

The shroud portion 404 is welded, in an embodiment, laser welded, to the airfoil portion 402 at a second end 4022 thereof.

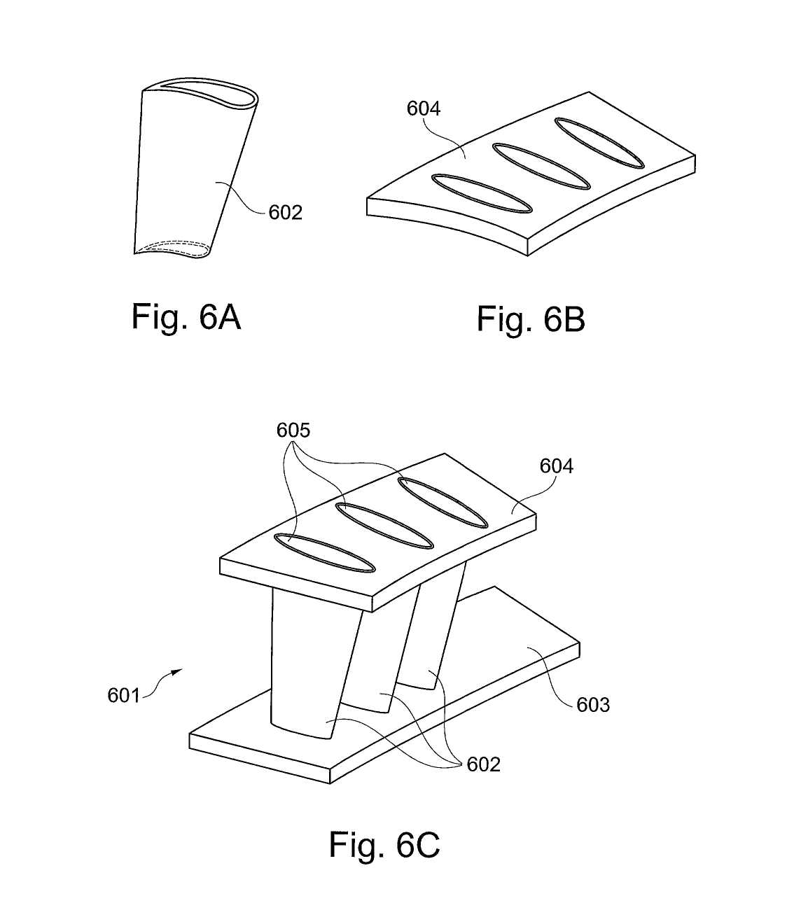

A similar manufacturing approach is used for the blade 601 in FIG. 6. In this case, the blade comprises a plurality of airfoil portions 602 (see FIG. 6A), in particular three (suitable numbers are in the range between two and five); the airfoil portions 602 are welded, in an embodiment, laser welded, to a same single shroud portion 604 (see FIG. 6B); the same is true for a single root portion 603; in this way, multi-blade, or “blade module”, 601 is obtained (see FIG. 6C). It is to be noticed that the root portion 603 and the shroud portion 604 are in the form of curved plates.

In alternative way to join the airfoil portion together with root portion and/or the shroud portion is by means of brazing.

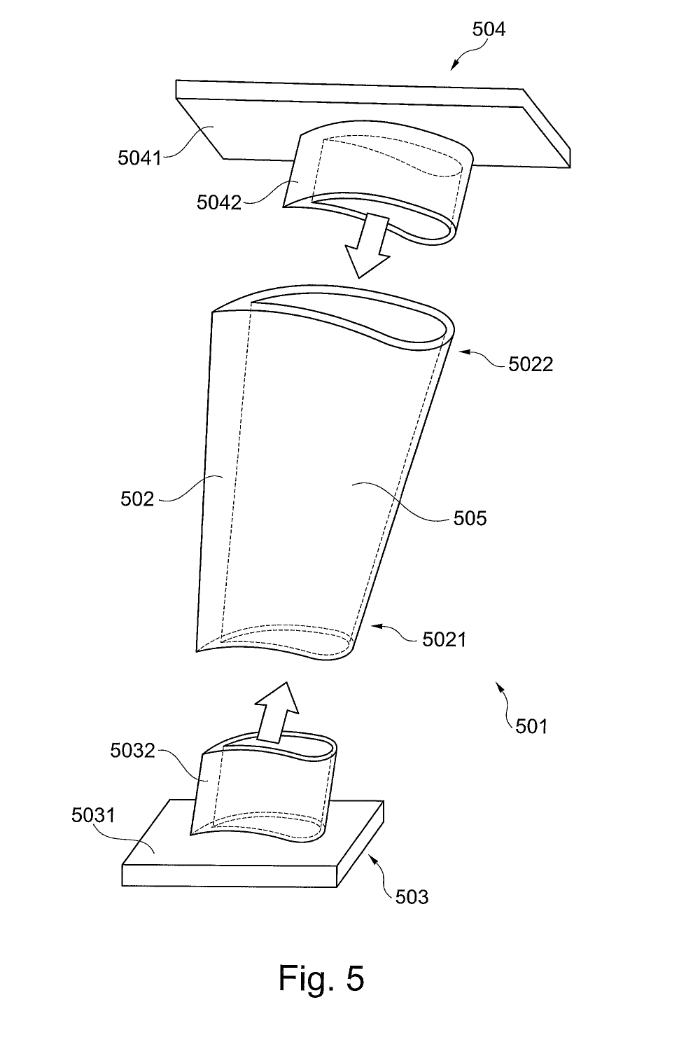

According to the embodiment of FIG. 5, a blade 501 is obtained by providing an airfoil portion 502, that may be similar to the airfoil portion 202 of FIG. 2, and brazing it, at a first end 5021, to a root portion 503 and, at a second end 5022, to a shroud portion 504.

According to the particular embodiment of FIG. 5, the root portion 503 comprises a (substantially flat) plate 5031 and a sleeve 5032; the sleeve 5032 is inserted into the internal cavity 505 of the airfoil portion 502. The sleeve 5032 has, in an embodiment, an external surface mating with the ruled surface of the internal cavity 505 of the airfoil portion 502 at the first end 5021; in this way, a good brazing may be achieved. A very good mating may be achieved if Wire EDM is used for forming the internal surface of the internal cavity 505 and milling is used for forming the external surface of the sleeve 5032; in fact, Wire EDM machines and milling machines are “computer aided” and therefore it is possible to set the same shape (or two very similar shapes) for distinct surfaces of two pieces. Also sleeve 5032 is typically hollow, as shown in FIG. 5, and obtained by Wire EDM.

According to the embodiment of FIG. 5, a blade 501 is obtained by providing an airfoil portion 502, that may be similar to the airfoil portion 202 of FIG. 2, and brazing it, at a first end 5021, to a root portion 503 and, at a second end 5022, to a shroud portion 504.

According to the particular embodiment of FIG. 5, the shroud portion 504 comprises a (substantially flat) plate 5041 and a sleeve 5042; the sleeve 5042 is inserted into the internal cavity 505 of the airfoil portion 502. The sleeve 5042 has, in an embodiment, an external surface mating with the ruled surface of the internal cavity 505 of the airfoil portion 502 at the first end 5021; in this way, a good brazing may be achieved. A very good mating may be achieved if Wire EDM is used for forming the internal surface of the internal cavity 505 and milling is used for forming the external surface of the sleeve 5042; in fact, Wire EDM machines and milling machines are “computer aided” and therefore it is possible to set the same shape (or two very similar shapes) for distinct surfaces of two pieces. Also sleeve 5042 is typically hollow, as shown in FIG. 5, and obtained by Wire EDM.

Brazing may be used instead of welding also for multi-blades, or “blade modules”, as the one in FIG. 6.

As an alternative to brazing for example in the embodiment of FIG. 5, an appropriate glue may be used; the glue must be selected taking into account the operating conditions (for example, temperature, pressure, flowing materials, . . . ) of the blade.

One or each of the root portion and the shroud portion may have a through hole; this is the case of the embodiments of e.g. FIGS. 4, 5, 6.

In this cases, for example, these through holes may be obtained by Wire EDM; in this way a perfect match may be achieved between the shape of the internal cavity of the airfoil portion at an end and the shape of the hole of the root or shroud portion, and a perfect welding may be carried out; in fact, Wire EDM machines are “computer aided” and therefore it is possible to set the same shape (or two very similar shapes) for distinct elements.

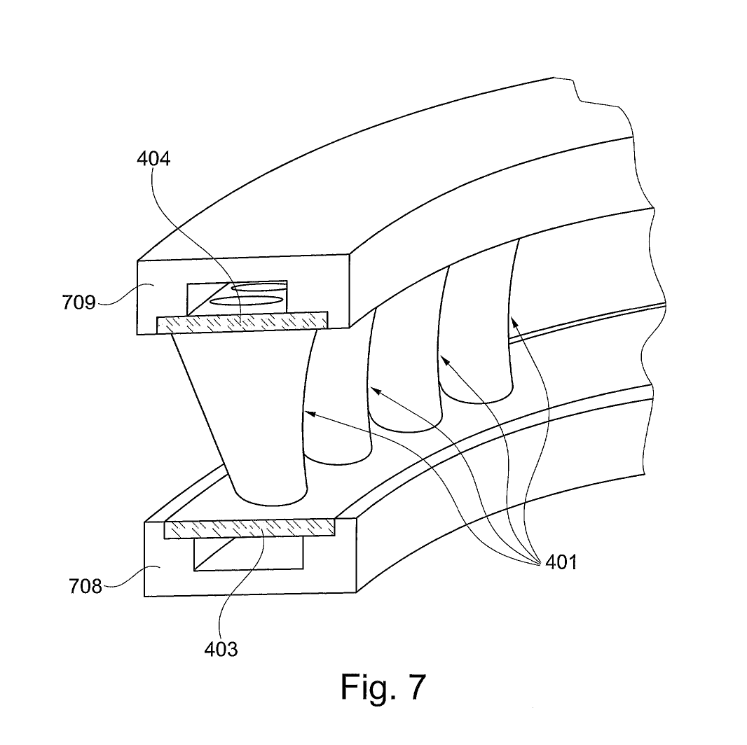

FIG. 7 shows an application of the blade 401 of FIG. 4; alternatively, the blade 501 of FIG. 5 or the multi-blade, or “blade module”, 601 of FIG. 6 may be used instead of the blade 401 of FIG. 4. According to this embodiment, each of the root portions 403 of the blades 401 are welded, in an embodiment, laser welded, to an inner ring 708 of a turbine, and each of the shroud portions 404 of the blades 401 are welded, in an embodiment, laser welded, to an outer ring 709 of a turbine; coupling between the root or shroud portion and the corresponding ring may be provided through a push fit or simply by a seat positioning.

Specifically, FIG. 7 shows partially the array of the stator blades of the last stage of a (axial flow) steam turbine. This arrangement, according to an embodiment, is very advantageous from the construction point of view.

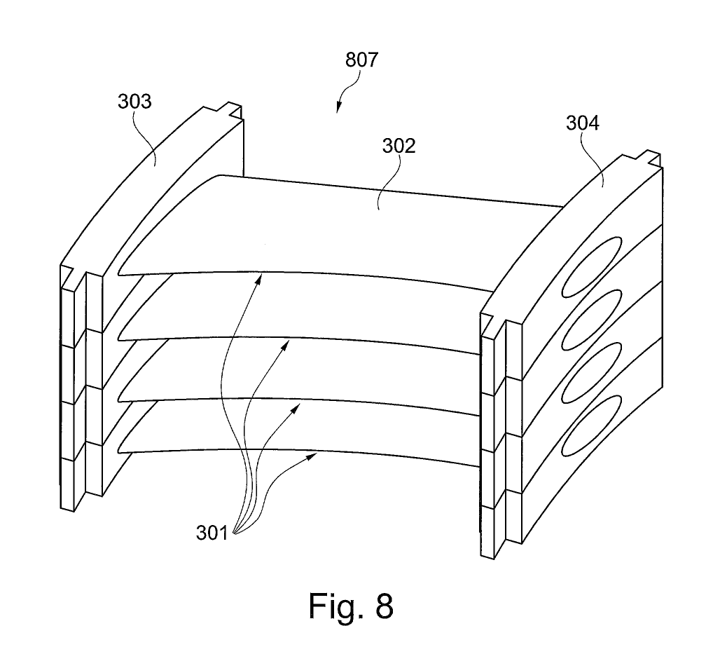

FIG. 8 shows a multi-blade, or “blade module”, 807 corresponding to the a plurality of blades 301 of FIG. 3 adjacent to each other; the blades 301 may be welded together or not.

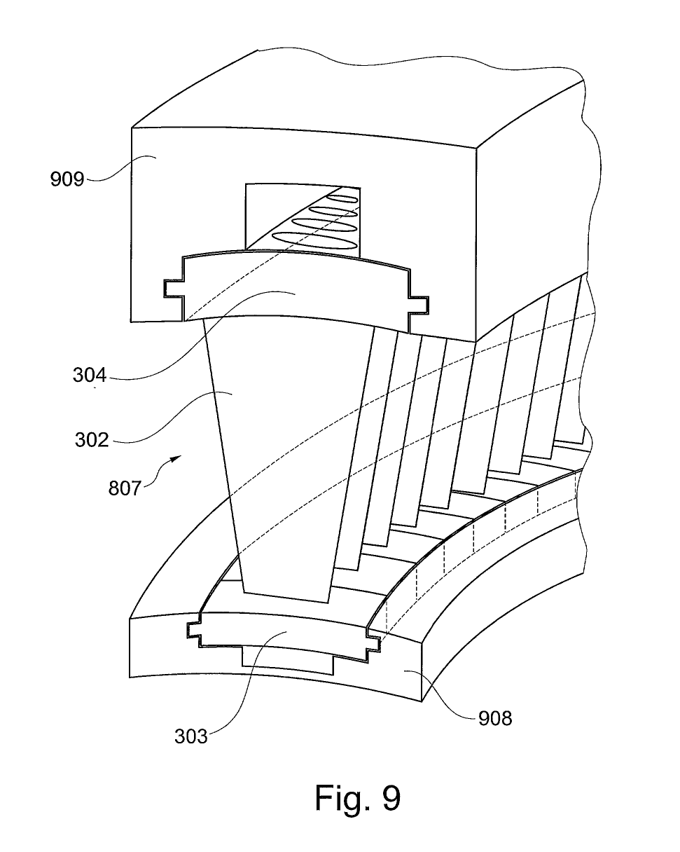

FIG. 9 shows an application of the multi-blade, or “blade module”, 807 of FIG. 8. According to this embodiment, each of the root portions 303 of the blades 301 are welded, in an embodiment, laser welded, to an inner ring 908 of a turbine, and each of the shroud portions 304 of the blades 301 are welded, in an embodiment, laser welded, to an outer ring 909 of a turbine; coupling between the root or shroud portion and the corresponding ring may be provided e.g. through a complementary shaping and a guided insertion (see FIG. 9).

Specifically, FIG. 9 shows partially the array of the stator blades of the last stage of a (axial flow) steam turbine. This arrangement, according to an embodiment, is very advantageous from the construction point of view.

In case that the present invention is used for stator blades of a steam turbine, holes and/or slots are typically provided for sucking condensation.

According to a first possibility, holes or slots transversal to the blade and extending from the external surface of the airfoil portion to the internal surface of the airfoil portion are made after forming the internal cavity of the blade. In this case, the holes or slots are obtained by electric discharge machining.

According to a second possibility, holes or slots transversal to the blade and extending from the external surface of the airfoil portion to the internal surface of the airfoil portion are made, and, in an embodiment, forming the internal cavity of the blade. In this case, the holes or slots are obtained by laser drilling or cutting.

The inner rings 708 and 908 and the outer rings 709 and 909 of FIGS. 7 and 9 have internal cavities extending all around the rings and in communication with internal cavities of the blades; such solution may be used for collecting condensation or for other purposes (for example circulating a fluid).

By using the manufacturing methods according to the present invention, novel and inventive turbomachine blades are obtained.

Essentially, at least one external or internal surface of the airfoil portion of the blade is a “ruled surface”; it is to be noticed that, by this term, it is meant not only a “simple” ruled surface, but also a “complex” ruled surface deriving from a combination of two or more ruled surfaces.

In typical applications of the present invention, the internal cavity extending entirely along the entire length of the airfoil portion is defined laterally by a ruled surface (see e.g. FIG. 2).

The blade may be designed so that, at any point of the airfoil portion, the distance (measured transversally to the blade) between the external surface and the external surface is variable; in particular, this distance is, in an embodiment, greater than 1 mm and smaller than 5 mm.

At a first end of the airfoil portion there is a first offset between the external surface and the internal surface; this first offset is, in an embodiment, constant and, in an embodiment, in the range between 1 mm and 5 mm.

At a second end of the airfoil portion there is a second offset between the external surface and the internal surface; this second offset is, in an embodiment, constant and, in an embodiment, in the range between 1 mm and 5 mm.

According to some embodiments, the root portion, the shroud portion and the airfoil portion of the blade are in a single piece; in this case, the ruled surface of the internal cavity extends also through the root portion and the shroud portion (see e.g. FIG. 3).

Alternatively, the root portion and the shroud portion are joined to the airfoil portion at their ends (see FIGS. 4 and 5).

In this case, the root portion may have a first (through) hole having a shape corresponding to the shape of the ruled surface of the internal cavity at said first end, and the shroud portion may have second (through) hole having a shape corresponding to the shape of the ruled surface of the internal cavity at said second end (see FIG. 4).

Still in this case, but according to a different manufacturing method, the root portion comprises a first sleeve having an external surface mating with the ruled surface of the internal cavity of the airfoil portion at the first end, and the shroud portion has a second sleeve having an external surface mating with the ruled surface of the internal cavity of the airfoil portion at the second end. In this case, the first sleeve has typically a first through hole defined laterally by a ruled surface and the second sleeve has typically a second through hole defined laterally by a ruled surface.

The construction details just described may be implemented not only in “single-blades” (for example 201 in FIG. 2, 301 in FIG. 3, 401 in FIGS. 4 and 501 in figure), but also in “multi-blades”, or “blade modules”, (for example 601 in FIG. 6 and 807 and FIG. 8).

The just described blades, whether “single-blades” or “multi-blades” may be effectively and efficiently used in the stages of turbomachines (see for example FIG. 7 and FIG. 9), in particular in a stator blade array of the last stages, in particular the very last stage, of a steam turbine.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A blade for a turbomachine, the blade comprising:
an airfoil portion, wherein the airfoil portion extends longitudinally for a length and comprises a first end and a second end, wherein the airfoil portion is defined laterally by an airfoil surface, wherein the airfoil portion further comprises an internal cavity extending entirely along the length, and wherein the internal cavity is defined laterally by a ruled surface.

2. The blade of claim 1, wherein the blade is arranged as a stator blade for a steam turbine, wherein the blade further comprises a root portion and a shroud portion, the first end adjacent to the root portion and the second end adjacent to the shroud portion.

3. The blade of claim 1, wherein at any point of the airfoil portion the distance between the airfoil surface and the ruled surface is variable.

4. The blade of claim 1, wherein at the first end there is a first offset between the airfoil surface and the ruled surface and at the second end there is a second offset between the airfoil surface and the ruled surface, wherein at least one of the first offset or the second offset is constant.

5. The blade of claim 2, wherein the root portion, the shroud portion and the airfoil portion are in a single piece, and wherein the ruled surface extends also through the root portion and the shroud portion.

6. The blade of claim 2, wherein the root portion and the shroud portion are joined to the airfoil portion at the first and second ends, wherein the root portion comprises a first hole having a shape corresponding to the shape of the ruled surface at the first end, wherein the shroud portion comprises a second hole having a shape corresponding to the shape of the ruled surface at the second end.

7. The blade of claim 2, wherein the root portion comprises a first sleeve comprising an external surface mating with the ruled surface of the airfoil portion at the first end or wherein the shroud portion comprises a second sleeve comprising an external surface mating with the ruled surface of the airfoil portion at the second end.

8. The blade of claim 7, wherein one or each of the first sleeve and the second sleeve comprises a second through hole defined laterally by a ruled surface.

9. The blade of claim 1, further comprising one single root portion, one single shroud portion and a plurality of airfoil portions, wherein each of the airfoil portions extends longitudinally for a length and comprises a first end and a second end, each of the first ends adjacent to the root portion and each of the second ends adjacent to the shroud portion, wherein each of the airfoil portions is defined laterally by an airfoil surface, wherein each of the airfoil portion comprises an internal cavity extending entirely along the length, and wherein the internal cavity is defined laterally by a ruled surface.

10. A turbomachine comprising:
a plurality of blades, wherein at least one of the plurality of blades comprises:
an airfoil portion, wherein the airfoil portion extends longitudinally for a length and comprises a first end and a second end, wherein the airfoil portion is defined laterally by an airfoil surface, wherein the airfoil portion further comprises an internal cavity extending entirely along said length, and wherein the internal cavity is defined laterally by a ruled surface.

11. A method of manufacturing a blade of a turbomachine comprising an airfoil portion, the method comprising:
obtaining at least one external or internal surface of the airfoil portion by wire electric discharge machining.

12. The method of claim 11, wherein the airfoil portion extends longitudinally for a length and comprises a first end and a second end, wherein the airfoil portion is defined laterally by an airfoil surface, wherein the airfoil portion further comprises an internal cavity extending entirely along the length, wherein the internal cavity is defined laterally by an internal surface, and wherein the internal surface is obtained by wire electric discharge machining.

13. The method of claim 11, wherein the airfoil portion is adjacent on a first side to a root portion and on a second the to a shroud portion, the method further comprising:
using wire electric discharge machining to create a through hole in both the root portion and the shroud portion respectively at the ends of the internal cavity.

14. The blade of claim 2, wherein at any point of the airfoil portion the distance between the airfoil surface and the ruled surface is variable.

15. The blade of claim 14, wherein at the first end there is a first offset between the airfoil surface and the ruled surface and at the second end there is a second offset between the airfoil surface and the ruled surface, wherein at least one of the first offset or the second offset is constant.

16. The blade of claim 2, wherein at the first end there is a first offset between the airfoil surface and the ruled surface and at the second end there is a second offset between the airfoil surface and the ruled surface, wherein at least one of the first offset or the second offset is constant.

17. The turbomachine of claim 10, wherein the at least one blade is arranged as a stator blade for a steam turbine, wherein the blade further comprises a root portion and a shroud portion, and the first end adjacent to the root portion and the second end adjacent to the shroud portion.

18. The turbomachine of claim 10, wherein at any point of the airfoil portion the distance between the airfoil surface and the ruled surface is variable.

19. The turbomachine of claim 10, wherein at the first end there is a first offset between the airfoil surface and the ruled surface and at the second end there is a second offset between the airfoil surface and the ruled surface, wherein at least one of the first offset or the second offset is constant.

20. The turbomachine of claim 10, wherein the at least one blade further comprises one single root portion, one single shroud portion and a plurality of airfoil portions, wherein each of the airfoil portions extends longitudinally for a length and comprises a first end and a second end, each of the first ends adjacent to the root portion and each of the second ends adjacent to the shroud portion, wherein each of the airfoil portions is defined laterally by an airfoil surface, wherein each of the airfoil portion comprises an internal cavity extending entirely along the length, and wherein the internal cavity is defined laterally by a ruled surface.
